(19) United States
(12) Patent Application Publication
(10) Pub. No.: US 2008/0022080 A1
(43) Pub. Date: Jan. 24, 2008

(54) Data access handling in a data processing system

(75) Inventor: Simon Craske, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/489,722

(22) Filed: Jul. 20, 2006

(51) Int. Cl. G06F 9/44

(52) U.S. Cl. 712/225

(57) ABSTRACT

A data processing system is provided comprising fetching logic for fetching program instructions for execution, a first data-accessing unit for handling decoding and execution of data access instructions and a second data-accessing unit for handling decoding and execution of program-counter-relative data access instructions. Handling of the program-counter-relative data access instructions by the second data-accessing unit is performed differently from the handling of the data access instructions by the first data-accessing unit.

### BACKGROUND OF THE INVENTION

1. Field of the Invention

The present invention relates to data access handling in a data processing system.

2. Description of the Prior Art

There is a continual drive in development of data processing devices to enhance processing performance to support ever more demanding data processing applications. The number of processing cycles required to load data for manipulation during a processing task represents an important constraint on processing performance. For example, program-counter-relative (i.e. literal pool) loads are typically used in back-to-back load pairs in order to fetch a pointer, which will subsequently be de-referenced. Such data load dependencies have an adverse effect on processor performance. Load performance can become a bottleneck, particularly in high performance data processing devices. In pipelined data processing systems, such as ARMR™ processors, computing performance can be enhanced by making load data values available as early as possible in the pipeline.

In known data processing systems data access instructions are handled by a general-purpose data handling unit.

### SUMMARY OF THE INVENTION

According to a first aspect the invention provides an apparatus for processing data comprising:

fetching logic for fetching program instructions for execution;

a first data-accessing unit for handling decoding and execution of data access instructions; and

a second data-accessing unit for handling decoding and execution of program-counter-relative data access instructions;
wherein said handling of said program-counter-relative data access instructions by said second data-accessing unit is performed differently from said handling of said data access instructions by said first data-accessing unit.

The present invention recognises that the efficiency of handling of program-counter-relative data access instructions can be improved by handling them differently from standard data access instructions. This allows for particular properties characteristic to program-counter-relative data access instructions (e.g. that the program-counter relative values are typically immutable) to be exploited to provide access more rapidly than if the instruction were handled using a standard, more general data handling unit. Separate handling of program-counter-relative data access instructions enables an increase in processor throughput in the data processing apparatus and alleviates back-to-back data load dependencies.

In one embodiment, the second data accessing unit comprises a literal pool cache for storing at least one data value corresponding to a respective program-counter-relative data access instruction. This enables previously accessed literal pool values to be stored such that they can be more efficiently accessed when a subsequent instruction associated with that literal pool value is handled by the data processing apparatus.

In one embodiment, the data processing apparatus is operable to execute instructions of an instruction set comprising a modification instruction such that execution of said modification instruction enables at least one cache entry in said literal pool cache to be modified. This provides an efficient and convenient way of maintaining the literal pool cache.

In one embodiment, second data accessing unit is operable to retrieve the stored data value from said literal pool cache at a time between decoding of a corresponding program-counter-relative data access instruction by said decoding logic and execution of said program-counter-relative data access instruction. This improves efficiency by providing access to the data value prior to execution of the data access instruction.

In one embodiment, the literal pool cache indexes said stored data value with a respective cache tag comprising at least one of:
(i) an address of a corresponding data access instruction;
(ii) a combination of said address and an opcode of said data access instruction; and
(iii) a memory address from which said stored data value is retrievable.
These cache tags allow for efficient retrieval of data and are straightforward to implement.

In one embodiment, at least one of the address of said corresponding data access instruction and the memory address from which said stored data value is retrievable is a virtual memory address. This provides additional flexibility to accommodate data processing systems having high demands on memory resources.

In one embodiment, at least one of the address of the corresponding data access instruction and the memory address from which the stored data value is retrievable is a physical memory address.

In one embodiment, the literal pool cache comprises eviction logic for invalidating a currently-cached data value. This provides for system recovery should when assumptions made about properties of the program-counter-relative loads prove not to hold e.g. if a literal pool value proves not to be immutable.

In one embodiment, the eviction logic is operable to perform the invalidation in response to a write to a memory address associated with a said currently-cached data value. This reduces the likelihood of a wrong load value being used in cases where the values prove to be non-immutable.

In one embodiment, the eviction logic is operable to update the currently-cached data value in response to a write to a memory address associated with the currently-cached data value. This is an efficient way of maintaining the literal pool cache and compensating for changes in program-counter-relative values.

In one embodiment, the eviction logic is activated in response to occurrence of an exception in the data processing apparatus. This reduces the likelihood of processing errors arising from the exception.

In one embodiment, the exception is at least one of an interrupt, a memory fault and a supervisor call. In another embodiment, the exception is associated with an attempt to write a value to a read-only page of a memory accessible by said data processing apparatus.

In one embodiment, the data processing apparatus is operable to execute instructions of an instruction set comprising an eviction instruction such that execution of said eviction instruction results in activation of said eviction logic. This provides an efficient and convenient way of invoking the eviction logic.

In one embodiment, the data processing apparatus is operable to execute instructions of an instruction set comprising a literal-pool accessing instruction and the eviction logic is activated in response to execution of the literal-pool accessing instruction. The literal-pool accessing instruction enables a handling mechanism different from that used for standard data accesses to be efficiently used and provides the programmer with more control of when the different handling mechanism is invoked.

In one embodiment, the data processing apparatus is responsive to a value of an eviction state-flag when performing processing operations such that the eviction logic is activated and deactivated in dependence upon a current value of said eviction state-flag.

According to a second aspect, the present invention provides a method for processing data comprising the steps of:

fetching program instructions for execution;

handling decoding and execution of data access instructions; and

handling decoding and execution of program-counter-relative data access instructions;
wherein said handling of said program-counter-relative data access instructions is performed differently from said handling of said data access instructions.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1A schematically illustrates a data processing apparatus capable of separately handling program-counter-relative data access instructions;

FIG. 1B schematically illustrates the modules of FIG. 1A used for handling decoding and execution of program-counter-relative data access instructions;

FIG. 2 schematically illustrates a sequence of program instructions comprising both a program-counter-relative data access instruction and non-program-counter-relative data access instructions;

FIG. 3 schematically illustrates the literal pool cache 160 of FIG. 1A in more detail;

FIG. 4 is a flow chart that schematically illustrates the data handling operations performed for program-counter-relative data access instructions;

FIG. 5 schematically illustrates a plurality of alternative conditions for invoking the eviction logic 162 of FIG. 1A.

### DESCRIPTION OF THE PREFERRED EMBODIMENTS

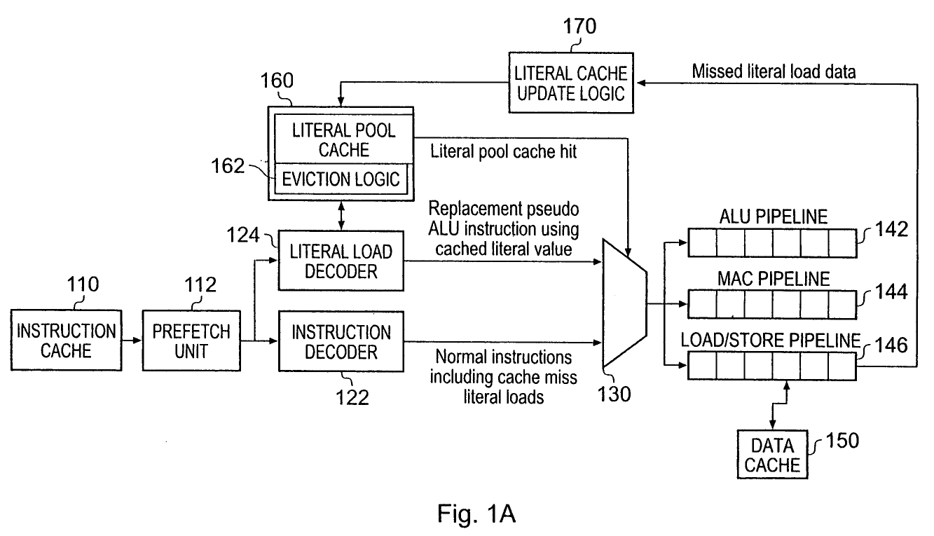

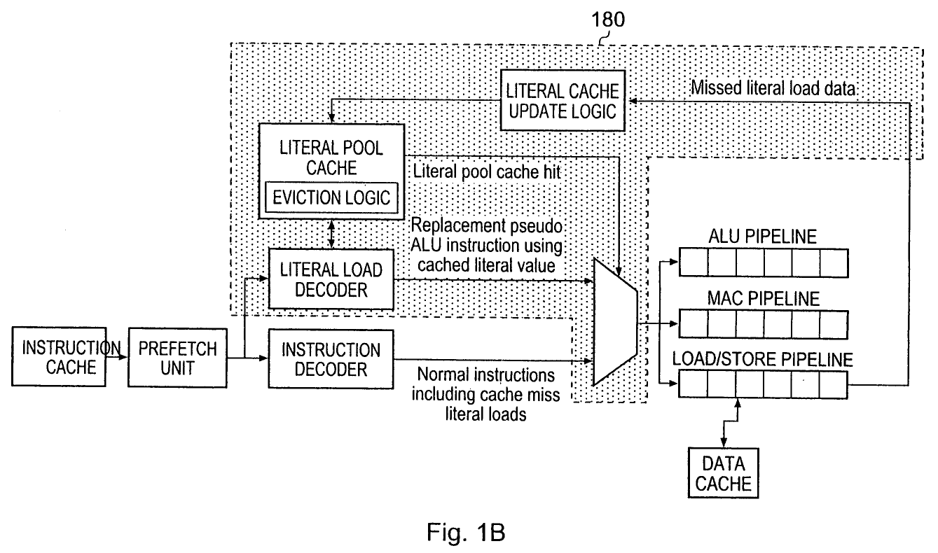

FIG. 1A schematically illustrates a data processing apparatus capable of separately handling decoding and execution of data access instructions and program-counter-relative data access instructions. The apparatus comprises: an instruction cache 110; a prefetch unit 112; an instruction decoder 122; a literal load decoder 124; a multiplexer 130; an arithmetic logic unit (ALU) pipeline 142; a multi-accumulate (MAC) pipeline 144; a load-store pipeline 146; a data cache 150; a literal pool cache 160; eviction logic 162; and literal cache update logic 170.

The data processing system of FIG. 1A performs data processing operations using a pipelined architecture in which data to be manipulated in stored in a set of registers accessible by the load/store pipeline 146. Data is accessed via these registers rather than directly from memory. The data processing apparatus performs data processing operations according to a set of program instructions executed by the processor (not shown). Instructions to be executed are prefetched by the prefetch unit 112. Typically, the instructions that are fetched will be retrieved from the instruction cache 110, although in some cases the instruction will have to be retrieved from main memory. The prefetch unit 112 supplies an instruction thus retrieved to either the instruction decoder 122 or the literal-load decoder 124.

The instruction decoder 122 decodes the prefetched program instruction and supplies the decoded instruction to the pipelines 142, 144, 146 via the multiplexer 130. Separate processing units are provided for the ALU pipeline 142, the MAC pipeline 144 and the load/store pipeline 146. The load/store pipeline 146 is dedicated to processing instructions which involve loading data into the registers for manipulation and storing the data back to the registers following execution of data processing operations. The load/store pipeline 146 has access to the data cache 150 to access data which is not currently accessible in the set of registers.

The decoupling of the load/store pipeline 146 from the ALU pipeline 142 and the MAC pipeline 144 enables more efficient processing since execution of load/store minstructions can often be constiained by the availability of external memory. In cases where access to the data cache 150 is required processing of load/store instructions is split over two processing cycles. Due to the-parallel nature of the ALU pipeline 142, the MAC pipeline 144 and a load/store pipeline 146, the execution of an ALU or map instruction should not be delayed by a waiting load/store instruction. This provides a software compiler with more freedom in scheduling code and helps to improve performance of the data processing system.

Some of the instructions awaiting execution in the pipelines 142, 144, 146 are likely to be branch instructions. Branch instructions are typically conditional instructions that require some condition to be tested (e.g. by examining a condition code register) before jumping to another instruction or just continuing through a current sequence of instructions. Such branching can cause delays in the pipelines since the result of the condition code needed by the branch instruction may not be available until three or four processing cycles after the instruction decoder encounters the branch. Accordingly, branch prediction is used to alleviate this delay.

To facilitate branch prediction, a branch target address cache (BTAC) is provided and maintained (not shown). The BTAC loads the majority of most recently encountered branches and represents a historical record of which branches have been taken previously and the frequency with which each branch is taken. If no record of the branch instruction can be found in the BTAC then a static branch prediction procedure is implemented, which involves taking a branch if the branch is going backwards and not taking the branch if the branch is going forwards. Data access instructions that are supplied to the instruction decoder 122 are resolved at an execution stage i.e. the data value is accessed from memory or from the data cache 150 only upon execution of the instruction.

The prefetch unit 112 is capable of discriminating between a literal pool access (i.e. a program-counter-relative data access) and other types of data access instructions. The prefetch unit 112 upon detection of a program-counter-relative data access instruction passes that instruction preferentially to the literal load decoder 124 where it will be handled differently from the way that normal data access instructions are handled by the instruction decoder 122 and the load/store pipeline 146. In particular, the literal load decoder 124 resolves the program-counter-relative data access instruction either during or at any point after the decoding of the instruction by accessing the literal pool cache 160 to retrieve a literal value associated with the program-counter-relative data access instruction.

The literal load decoder 124 then modifies other pipelined instructions by outputting pseudo-instructions (e.g. pseudo ALU instructions) that incorporate the cache literal value to the multiplexer 130 and feeds those modified instuctions to the ALU pipeline 142 or the MAC pipeline 144 as appropriate. Accordingly, the use of the literal load decoder 124 together with the literal pool cache 1-60 obviates the requirement to use the load/store pipeline 146 to access data associated with literal pool variables. This avoids the load penalties that can be associated with accessing data via the load/store pipeline 146. The use of the literal load decoder 124 and the literal pool cache 160 alleviates some cases of back-to-back data load dependency and allows values returned from a previously executed program-counter-relative data load to be derived earlier in the pipeline than otherwise would be the case if the load/store pipeline had to be used to access that data.

The literal pool cache 160 stores previously accessed literal pool values as data and indexes those stored literal pool values using at least one of:
(i) an address of the data access instruction;
(ii) a combination of the instruction address and an op code of the data access instruction;
(iii) the memory address from which the data value would normally be accessed.

It will be appreciated that the literal pool cache 160 will store only a subset of literal pool values corresponding to literal loads that had previously been executed. Accordingly, if the literal load decoder 124 determines that a given program-counter-relative data access does not have a corresponding literal value stored in the literal pool cache 160, then that data access instruction will be decoded by the standard instruction decoder 122 in the normal way by forwarding that data access instruction to the load/store pipeline 146 for execution. However, once that data access value has been resolved at the execution stage in the load/store pipeline 146 the literal load data associated with the cache miss is supplied to the literal cache update logic 160, which updates the literal pool cache to include an entry corresponding to that program-counter-relative data access instruction (i.e. the instruction that resulted in the literal pool cache miss).

In the event of a literal pool cache hit during decoding by the literal load decoder 124, ALU instructions and MAC instructions that require that cache literal value are modified such that the load/store pipeline 146 is not required to access the literal value and then these modified instructions are supplied to the multiplexer 130.

The handling of program-counter-relative data access instructions using the literal load decoder 124 and the literal pool cache 160 of FIG. 1A relies on the assumption that all program-counter-relative data accesses (loads and stores) return immutable values. In other words, it is assumed that the literal value associated with the program-counter-relative data access instruction will not change from one execution to the next execution of that instruction. The present technique differs from known systems for load address prediction. In particular, according to the present technique there is no requirement to rewind the pipeline if it is discovered at a later stage that a prediction was incorrect. Rather, execution of program instructions continues regardless of whether the literal value retrieved from the literal pool cache 160 was actually the current value stored in memory. Accordingly, the system of FIG. 1A is lower in power and easier to implement than a system that incorporates load data value prediction. Insertion of the literal value retrieved from the literal pool cache 160 in the case of program-counter-relative data access instructions for which the cache literal values are immutable avoids the need to:—
(i) recompute the address as it would have been at execution (allowing for a base register to have been modified etc) and compare it will the address that was predicted; or
(ii) actually retrieve the value that would have been returned at the write back stage (allowing it to have been modified by another operation) and compare it with the value that was predicted.

Thus, according to the present technique, a basic assumption is made that literal pool variables are immutable and this assumption is exploited to enable more efficient handling of program-counter-relative data access instructions.

FIG. 1B schematically illustrates the data processing system of FIG. 1A but highlights via box 180 the elements of the second data-accessing unit for handling decoding and execution of program-counter-relative data access instructions. As shown the second data-accessing unit comprises the literal load decoder 124, the literal pool cache 160, the literal cache update logic 180 and the multiplexer 130. It will be appreciated that although the literal load decoder 124 is shown as a separate unit from the instruction decoder 122 in this particular embodiment, in alternative embodiments the functionality of the literal load decoder 124 and the standard instruction decoder 122 could be combined in a single decoding unit operable to perform handling of the program-counter-relative data access instructions differently from other data access instructions.

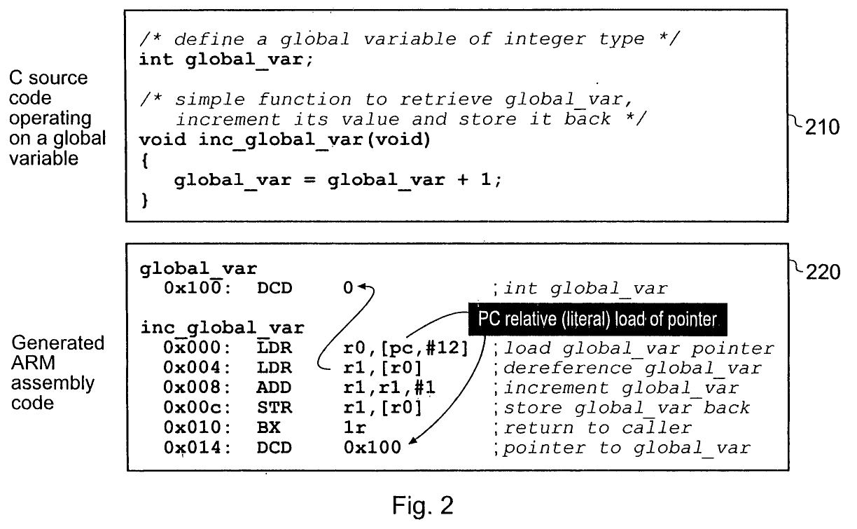

FIG. 2 schematically illustrates a sequence of program instructions comprising both a program-counter-relative data access instruction and non-program-counter-relative data access instructions. The upper portion 210 of FIG. 2 comprises C computer program code that defines a simple function operable to retrieve a global variable “global_var”, to increment its value and to store it back to memory. The lower portion 220 of FIG. 2 illustrates the ARM assembly code equivalent to the C code 210. The assembly code comprises a number of load instructions LDR and a store instruction STR. In the assembly code the instruction at address 0×100 initialises the value of the global variable to zero. The assembly code instruction 0×000 is an ARM load instruction (LDR) corresponding to a literal load i.e. program-counter-relative instruction. This instruction specifies storage of an address corresponding to the value of the program counter plus the immediate value 12 into the register R0. The load instruction at address 0×004 serves to de-reference the global variable by retrieving the actual value of the variable via the pointer. In particular, the value of the data stored at the address PC+12 is loaded into register R1. Note that the actual value is zero in accordance with the instruction at address 0×100.

Instruction 0×008 increments the global variable by adding 1 to the value stored in register R1. The next instruction 0×00C is a store instruction (STR) that serves to copy the value from R1 into the register R0. The instruction at address 0×101 serves to return from the function to the calling program. The DCD assembler directive at address 0×014 puts a literal value in memory. Accordingly, the instructions 0×00 and 0×014 together represent the PC relative (literal) load of the pointer. This PC relative literal load is decoded by the literal load decoder 124 of FIG. 1A so that on subsequent executions of the load instruction the values stored in PCX12 can be retrieved directly from the literal pool cache 160 (of FIG. 1) and used by the ALU and/or MAC pipelines 142, 144.

Examples of program counter relative loads are loads associated with pointer addresses, global variable addresses and function addresses. Program code typically refers to a single literal pool value from several locations in the program instruction sequence and typically repeatedly in close temporal proximity. Thus use of the literal pool cache 160 and the literal load decoder 124 of FIG. 1A alleviates some case of back-to-back data load dependency. The literal load corresponding to the instruction address 0×000 in assembly code 220 of FIG. 2 is followed by a standard load at address 0×004 and standard store instruction at address 0×00C. These standard load and store instructions are decoded by the instruction decoder 122 of FIG. 1 and the data value is accessed by execution of these instructions using the load/store pipeline 146.

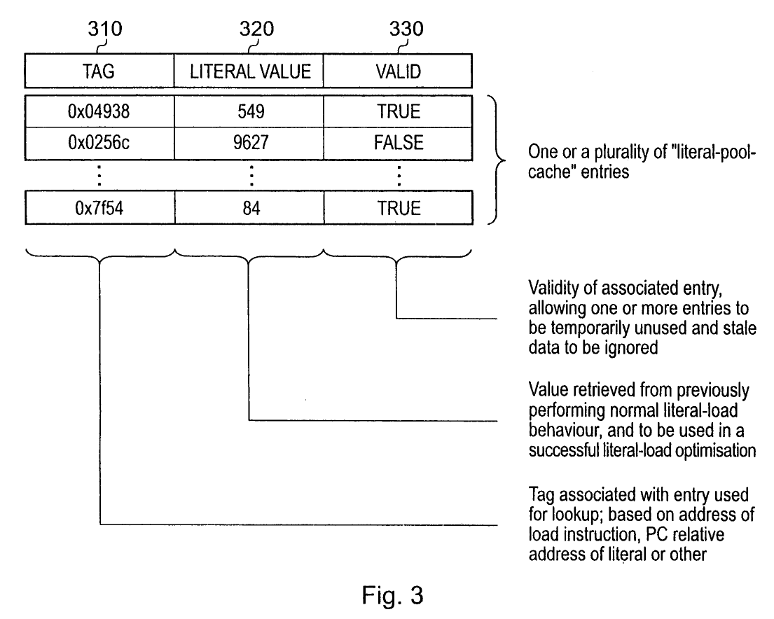

FIG. 3 schematically illustrates the literal pool cache 160 of FIG. 1A in more detail. The literal pool cache 160 is similar in its organisation to the branch target address cache used by the branch prediction mechanism of a data processing system. The literal pool cache comprises a cache tag field 310, a literal value field 320 and a valid field 330. The cache target field 310 stores an index or tag that is used to perform look up of the stored literal value. In this particular embodiment, the cache target is based on the address of the associated load instruction. However, in alternative embodiments the cache tag is a combination of the instruction address an op code of the data access instruction and/or the actual memory address from which the data value is retrievable (i.e. the address from which the data value would normally be accessed). In FIG. 3 the cache address tag is a physical memory address, but in an alternative embodiment the cache address tag is a virtual memory address.

The literal value field 320 stores the value retrieved from a previous execution of the program counter relative data access instruction. This value would be retrieved at the execution stage by the load/store pipeline 146 (see FIG. 1A). The valid field 330 provides an indication of the validity of the associated cache entry and allows one or more cache entries to be invalidated such that the literal values stored therein are not used by the data processing system. Literal values stored in the literal pool cache 160 for which the valid field 330 is false will result in a cache miss so that the literal value will have to be accessed via the standard data handling route comprising the load/store pipeline 146 of FIG. 1A.

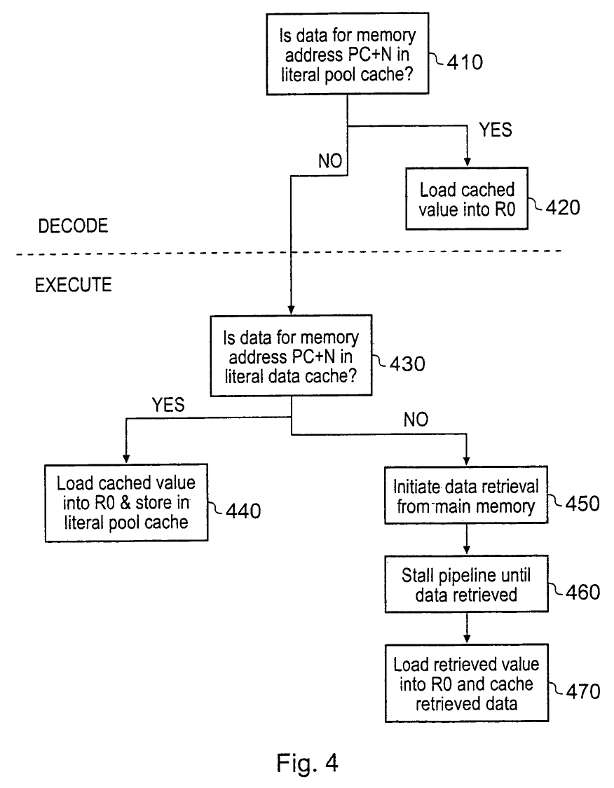

FIG. 4 is a flow chart that schematically illustrates the data handling operations performed for program-counter-relative data access instructions. The flow chart illustrates the execution steps both for instructions for which there is a literal pool cache hit and instructions for which there is a literal pool cache miss. The process begins at stage 410 when the program counter relative instruction is recognised by the prefetch unit and passed to the decoder literal load decoder 124 whereupon the literal load decoder 124 of FIG. 1A establishes whether the literal value associated with the data access is stored in the literal pool cache 160. If this value is in fact stored in the cache then the process proceeds to stage 420 where the literal value is read from the cache and stored into a register for manipulation by instructions of the ALU pipeline 142 or the MAC pipeline 144 (see FIG. 1A).

However, if at stage 410 it is determined that there is a cache miss then the process proceeds to stage 430 where upon the program counter relative data access instruction is supplied to the load/store pipeline 146 for execution. Execution of the instruction at stage 430 comprises a check for whether the literal pool value is stored in the data cache 150. If the data is stored in the cache then the process proceeds to stage 440 where the data is loaded from a data cache into the register and is also provided to the literal cache update logic 170 so that it can be stored in the literal pool cache 160 for use during a subsequent execution of that instruction. If at stage 430 there is a miss in the data cache 150 the process proceeds to stage 450 where a data retrieval is initiated from main memory. Next at stage 460 the load/store pipeline 146 is stalled pending retrieval of the requested data from the memory. Finally at stage 470 the value retrieved from memory is stored into the register and the retrieved data is cached in the data cache 150. It can be seen that the literal pool cache hit results in the literal value being accessed at an earlier stage than it otherwise would be if the instruction was executed via the load/store pipeline 146.

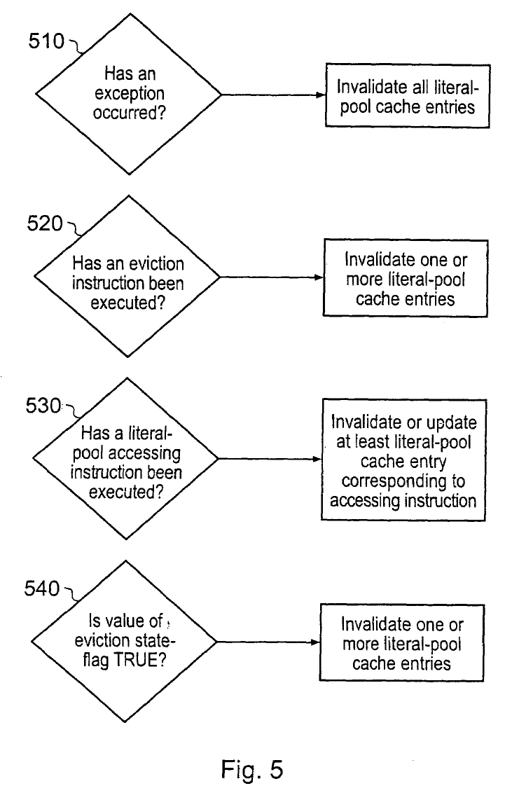

FIG. 5 schematically illustrates a number of alternative situations in which the eviction logic 162 of the literal pool cache 160 of FIG. 1A is activated to effect eviction of invalidation of one or more literal pool cache entries. FIG. 5 shows a plurality of alternative conditions for invoking the eviction logic 162. Eviction condition 510 depends upon whether or not an exception has occurred in the data processing system. If an exception is in fact detected then all literal pool cache entries are invalidated. Examples of exceptions that occur and which are operable to trigger invalidation of the literal pool cache entries are an interrupt, a memory fault or a supervisor call.

Eviction condition 520 involves determining whether a special-purpose eviction instruction has been executed by the data processing system. In the event that the eviction instruction has in fact been executed then one or more literal pool cache entries are invalidated dependent upon the operations specified by the eviction instruction. Eviction condition 530 involves determining whether a literal pool accessing instruction has been executed. If a literal pool accessing instruction has been executed (e.g. a literal pool store operation) then the associated literal pool cache entry can either be
(i) invalidated; or
(ii) updated

in accordance with any change to the literal value as a result of the literal pool accessing instruction. Eviction condition 540 involves a check as to whether the value of an eviction state-flag is true. In the event that the eviction state-flag is true then one or more of the literal pool cache entries will be invalidated. The state flag provides a mechanism to fully disable the functionality of the literal pool cache 160.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. Apparatus for processing data comprising:
fetching logic for fetching program instructions for execution;
a first data-accessing unit for handling decoding and execution of data access instructions; and
a second data-accessing unit for handling decoding and execution of program-counter-relative data access instructions;
wherein said handling of said program-counter-relative data access instructions by said second data-accessing unit is performed differently from said handling of said data access instructions by said first data-accessing unit.

2. Apparatus as claimed in claim 1, wherein said second data accessing unit comprises a literal pool cache for storing at least one data value corresponding to a respective program-counter-relative data access instruction.

3. Apparatus as claimed in claim 2, wherein said data processing apparatus is operable to execute instructions of an instruction set comprising a modification instruction such that execution of said modification instruction enables at least one cache entry in said literal pool cache to be modified.

4. Apparatus as claimed in claim 2, wherein said second data accessing unit is operable to retrieve said stored data value from said literal pool cache at a time between decoding of a corresponding program-counter-relative data access instruction by said decoding logic and execution of said program-counter-relative data access instruction.

5. Apparatus as claimed in claim 2, wherein said literal pool cache indexes said stored data value with a respective cache tag comprising at least one of:
(iv) an address of a corresponding data access instruction;
(v) a combination of said address and an opcode of said data access instruction; and
(vi) a memory address from which said stored data value is retrievable.

6. Apparatus according to claim 4, wherein at least one of said address of said corresponding data access instruction and said memory address from which said stored data value is retrievable is a virtual memory address.

7. Apparatus according to claim 4, wherein at least one of said address of said corresponding data access instruction and said memory address from which said stored data value is retrievable is a physical memory address.

8. Apparatus as claimed in claim 2, wherein said literal pool cache comprises eviction logic for invalidating a currently-cached data value.

9. Apparatus as claimed in claim 7, wherein said eviction logic is operable to perform said invalidation in response to a write to a memory address associated with a said currently-cached data value.

10. Apparatus as claimed in claim 7, wherein said eviction logic is operable to update said currently-cached data value in response to a write to a memory address associated with said currently-cached data value.

11. Apparatus as claimed in claim 7, wherein said eviction logic is activated in response to occurrence of an exception in said data processing apparatus.

12. Apparatus as claimed in claim 10, wherein said exception is at least one of an interrupt, a memory fault and a supervisor call.

13. Apparatus as claimed in claim 10, wherein said exception is associated with an attempt to write a value to a read-only page of a memory accessible by said data processing apparatus.

14. Apparatus as claimed in claim 7, wherein said data processing apparatus is operable to execute instructions of an instruction set comprising an eviction instruction such that execution of said eviction instruction results in activation of said eviction logic.

15. Apparatus as claimed in claim 7, wherein said data processing apparatus is operable to execute instructions of an instruction set comprising a literal-pool accessing instruction and wherein said eviction logic is activated in response to execution of said literal-pool accessing instruction.

16. Apparatus as claimed in claim 7, wherein said data processing apparatus is responsive to a value of an eviction state-flag when performing processing operations such that said eviction logic is activated and deactivated in dependence upon a current value of said eviction state-flag.

17. Method for processing data comprising the steps of:
fetching program instructions for execution;
handling decoding and execution of data access instructions; and
handling decoding and execution of program-counter-relative data access instructions;
wherein said handling of said program-counter-relative data access instructions is performed differently from said handling of said data access instructions.

18. Apparatus for processing data comprising:
means for fetching program instructions for execution;
means for handling decoding and execution of data access instructions; and
means for handling decoding and execution of program-counter-relative data access instructions;
wherein said handling of said program-counter-relative data access instructions is performed differently from said handling of said data access instructions.
